(19) United States
(12) Patent Application Publication
(10) Pub. No.: US 2026/0248663 A1
(43) Pub. Date: Aug. 27, 2026

(54) MEDICAL EVACUATION LITTER SYSTEM AND METHOD

(71) Applicant: Christopher Swickard, Arlington, VA (US)

(72) Inventor: Christopher Swickard, Arlington, VA (US)

(21) Appl. No.: 19/063,838

(22) Filed: Feb. 26, 2025

(51) Int. Cl. A61G 1/04; A61G 1/048

(52) U.S. Cl. CPC A61G 1/042; A61G 1/048

(57) ABSTRACT

A medical evacuation litter system may comprise a tub-like structure configured to secure a patient. The system may include a plurality of cross-body shoulder straps configured to be worn by multiple carriers. A plurality of handles may be integrated into the tub-like structure. The tub-like structure may be configured to be carried at approximately hip height of the carriers when the cross-body shoulder straps are worn. The system may allow hands-free operation by the carriers. The cross-body shoulder straps may be configured to distribute weight among four to six carriers. The tub-like structure may comprise military-grade webbing. The system may further include a body cover with an external double-strapped torso belt and an internal single strap wide waist belt. The handles may correspond to each of the cross-body shoulder straps. The tub-like structure may have specific dimensions. The system may also include adjustable carrier straps.

### FIELD OF THE INVENTION

The present disclosure relates generally to medical evacuation equipment, and more particularly to a litter system for transporting injured individuals in challenging environments.

### BACKGROUND OF THE INVENTION

Medical evacuation of injured individuals from combat zones or rough terrain presents significant challenges. Conventional litters often require carriers to use one or both hands, limiting their ability to navigate difficult terrain or respond to threats. Additionally, traditional carrying methods can create an unbalanced and shortened gait resulting in increased strain on the carriers.

There remains a need for improved medical evacuation systems that allow for more efficient and secure transport of injured individuals while providing carriers with greater freedom of movement and ability to respond to environmental challenges.

### SUMMARY

The present disclosure may provide a medical evacuation litter system. The system may include a tub-like structure configured to secure a patient. The system may also include a plurality of cross-body shoulder straps configured to be worn by multiple carriers. The system may further include a plurality of handles integrated into the tub-like structure. In some embodiments, the tub-like structure may be configured to be carried at approximately hip height of the carriers when the cross-body shoulder straps are worn. In certain embodiments, the system may be configured to allow hands-free operation by the carriers. In one or more embodiments, the system may be configured to allow hands-free operation at various heights by the carriers.

The present disclosure may also provide a method of transporting an injured individual. The method may include securing the individual in a tub-like structure of a medical evacuation litter. The method may also include engaging multiple carriers with the medical evacuation litter using cross-body shoulder straps. The method may further include elevating the medical evacuation litter to approximately hip height of the carriers and transporting the individual while maintaining freedom of movement for the carriers. These and other features, aspects, and advantages of the present disclosure may be better understood with reference to the following description and appended claims.

### BRIEF DESCRIPTION OF THE DRAWINGS

The accompanying drawings, which are incorporated in and constitute a part of this specification, illustrate embodiments of the disclosure and, together with the description, serve to explain the principles of the disclosure.

FIG. 1 illustrates various views of an exemplary medical evacuation litter according to embodiments of the present disclosure.

FIG. 2 depicts a weight distribution diagram for an exemplary medical evacuation litter according to embodiments of the present disclosure.

FIG. 3 shows stitching locations and weight distribution details for an exemplary medical evacuation litter according to embodiments of the present disclosure.

FIG. 4 illustrates a progression of overlapping sequential patterns for construction of an exemplary medical evacuation litter according to embodiments of the present disclosure.

FIG. 5 depicts estimated dimensions and construction details of a medical evacuation litter tub and varying handles designs according to embodiments of the present disclosure.

FIG. 6 shows center cross-body shoulder strap dimensions and construction details according to embodiments of the present disclosure.

FIG. 7 illustrates angle and corner cross-body shoulder strap estimated dimensions and construction details according to embodiments of the present disclosure.

FIG. 8 depicts patient body cover estimated dimensions and construction details according to embodiments of the present disclosure.

FIG. 9 shows optional design with placement and hardware for an adjustable cross-body shoulder carrier strap details according to embodiments of the present disclosure.

FIG. 10 is a diagram illustrating a medical evacuation litter designed to distribute weight among four to six carriers.

FIG. 11 is a diagram illustrating an assembly of a medical evacuation litter system.

### DETAILED DESCRIPTION

The present disclosure may be understood more readily by reference to the following detailed description of exemplary embodiments and the examples included therein. Before the present devices, systems, and methods are disclosed and described, it may be understood that the present disclosure is not limited to the specific embodiments described herein, but may include numerous modifications, alterations, and variations that fall within the scope of the appended claims.

Reference will now be made in detail to exemplary embodiments of the present disclosure, examples of which are illustrated in the accompanying drawings. Wherever possible, the same reference numbers will be used throughout the drawings to refer to the same or like parts.

It should be appreciated that this description is for illustrative purposes only and is not intended to limit the scope of the present disclosure. In addition, various features are described herein in a certain order or arrangement, but such features may be combined, separated, or rearranged without departing from the spirit and scope of the disclosure. In other instances, well-known features have not been described in detail to avoid unnecessarily complicating the description.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

Unless otherwise defined, all technical and scientific terms used herein may have the same meaning as commonly understood by one of ordinary skill in the art to which this disclosure belongs. The terminology used in the description herein may be for describing particular embodiments only and may not be intended to limit the scope of the present disclosure.

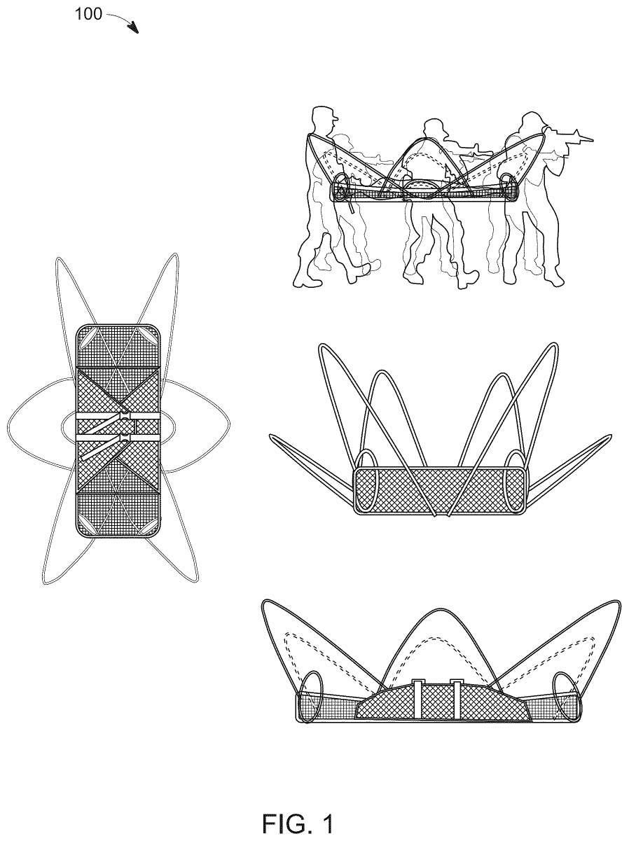

Referring now to FIG. 1, an exemplary medical evacuation litter 100 according to embodiments of the present disclosure is illustrated. The medical evacuation litter 100 may include a tub-like structure 102 configured to secure a patient. The tub-like structure 102 may be formed from a durable, lightweight rip-stop and webbing materials suitable for use in challenging environments. The medical evacuation litter 100 may also include a plurality of cross-body shoulder straps 104. The cross-body shoulder straps 104 may be configured to be worn by multiple carriers across the body or over the shoulders, typically four to six individuals. The configuration of the cross-body shoulder straps 104 may be designed to overlap/intersect and assist in distributing the weight of the patient amongst carrier bodies when employing the medical evacuation litter 100 and patient across the carriers' bodies, allowing for more comfortable and stable transport. Integrated handles 106 may be provided as part of the tub-like structure 102. These handles 106 may serve as alternative carrying points or provide additional support when used in conjunction with the cross-body shoulder straps 104.

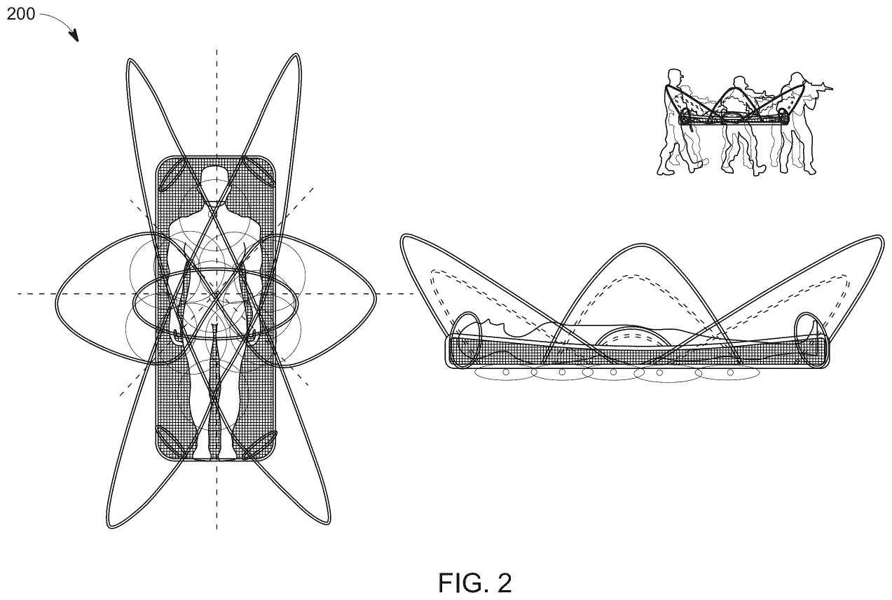

FIG. 2 illustrates a weight distribution diagram of the patient created by the overlapping/intersection of the webbing lattice incorporated in the tub design for the medical evacuation litter 100. The cross-body shoulder straps 104 may be arranged to cross over the body and opposite shoulder of each carrier. This configuration may allow for freedom of both hands while transporting a wounded individual, may allow for unrestricted gait, and may allow each of the cross-body shoulder straps 104 to have a corresponding handle 106 for additional stability or lifting support when needed. The symmetrical design of the medical evacuation litter 100 may not discriminate regarding the placement of the injured individual.

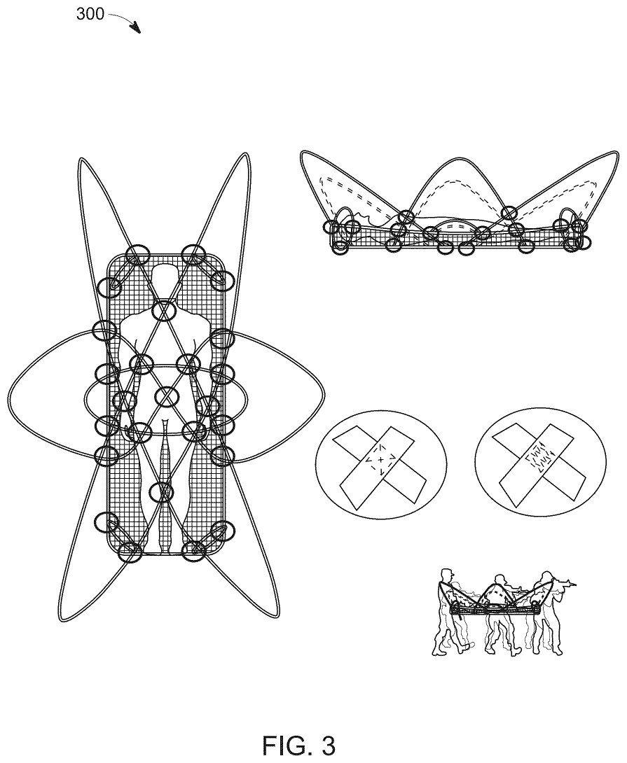

As shown in FIG. 3, the medical evacuation litter 100 may incorporate military-grade webbing, which may be approximately 2-3 inches wide. The webbing may be box or diamond-stitched at all intersections, which may total 25 in some embodiments. This stitching pattern may enhance the overall strength and durability of the medical evacuation litter 100.

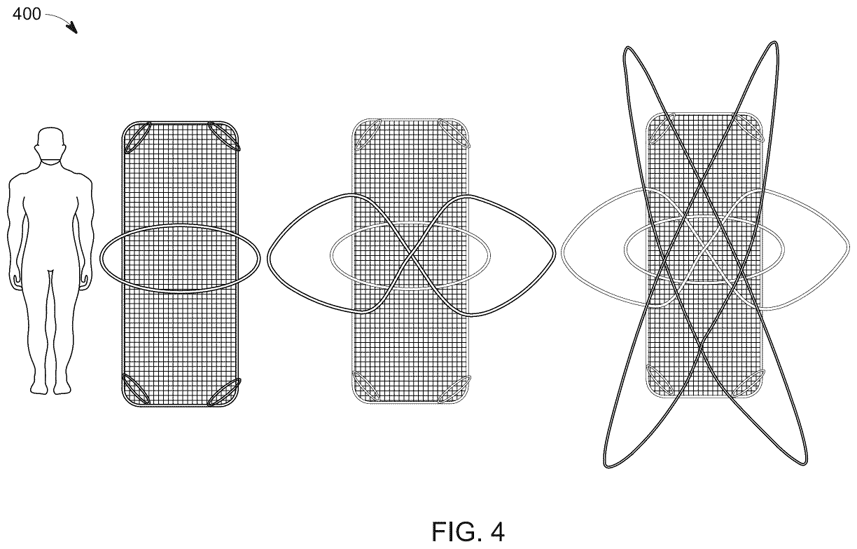

FIG. 4 depicts a progression of overlapping patterns that may be incorporated into the design of the medical evacuation litter 100. These patterns may contribute to the overall structural integrity and weight distribution capabilities of the system.

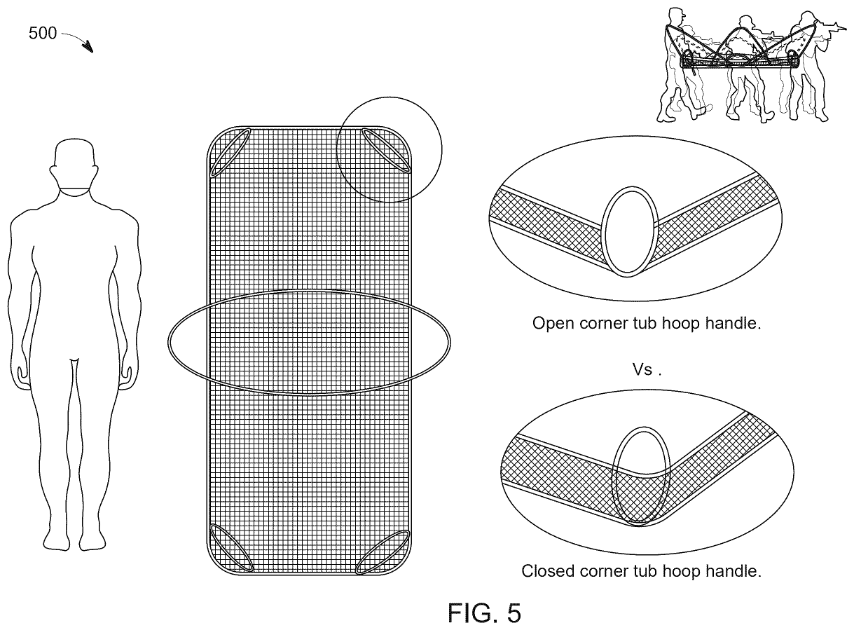

Referring to FIG. 5, exemplary dimensions for the tub-like structure 102 are illustrated. The tub-like structure 102 may be approximately 27.5 inches tall, 20 inches wide at the middle, and 15 inches wide at the top corners. These dimensions may be estimates and may vary in different embodiments.

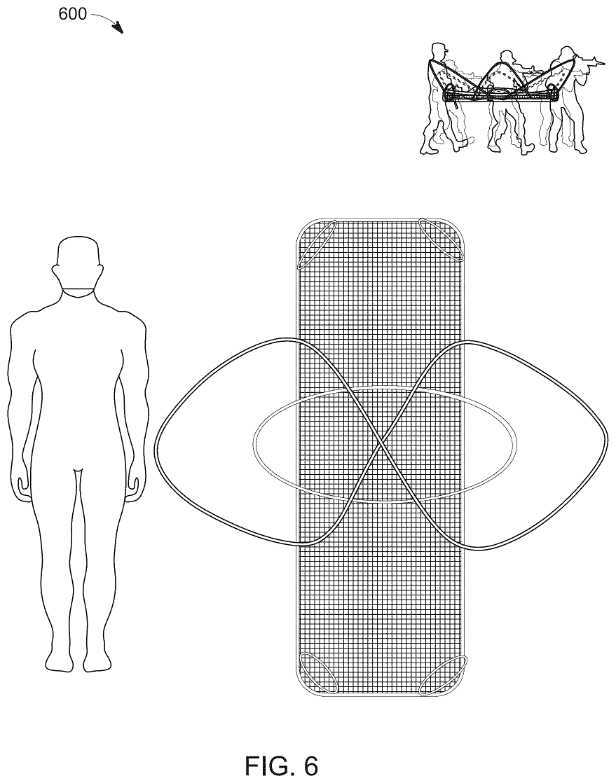

FIG. 6 shows center cross-body shoulder strap dimensions and construction details. The center cross-body shoulder straps may include sections measuring approximately 37.5 inches, 12.5 inches, 24 inches, and 50 inches in length. These measurements may be estimates and may vary in different embodiments.

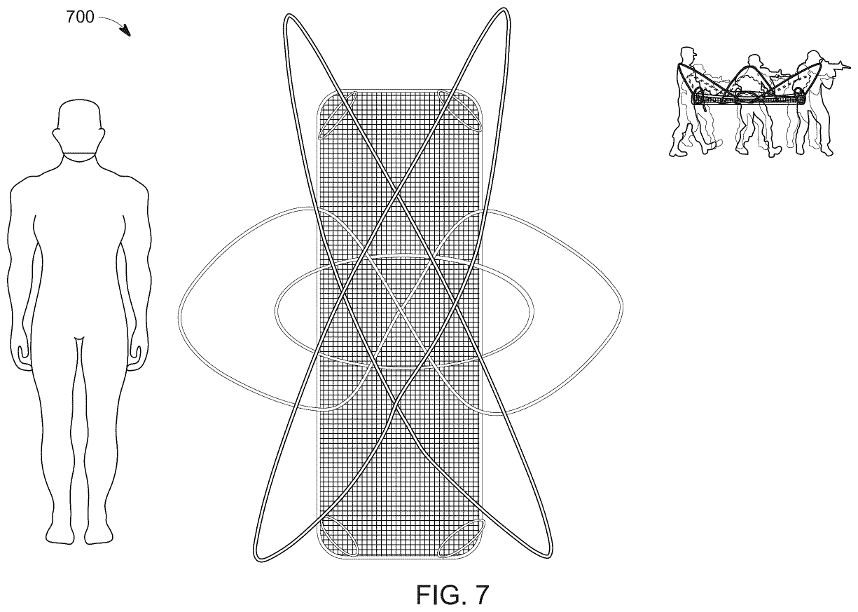

FIG. 7 illustrates angle and corner strap dimensions. The overall width of the cross-body shoulder strap system may be approximately 48 inches (122 cm), with a height of approximately 75 inches (190 cm). Various strap sections may measure 12.5 inches, 24 inches, 25 inches, 36 inches, 50 inches, and 6 inches in length. These measurements may be estimates and may vary in different embodiments.

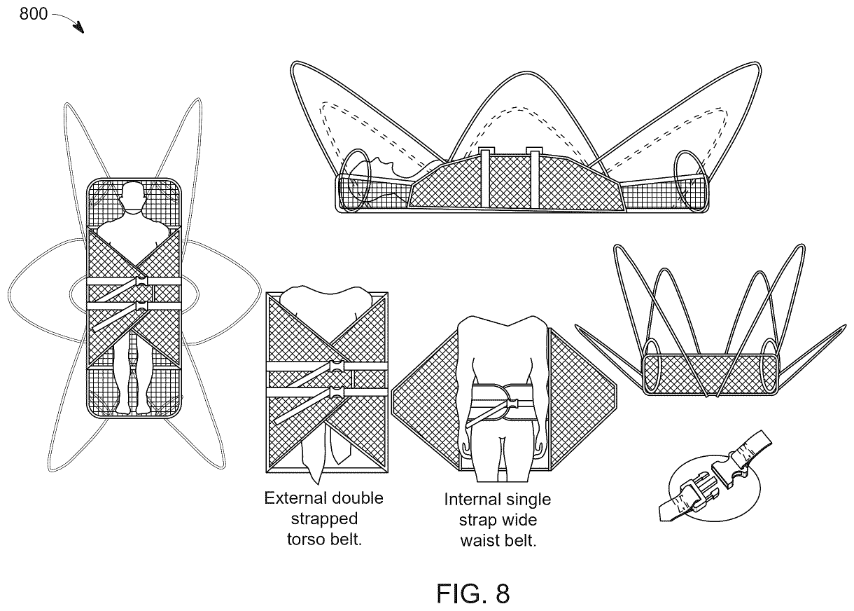

FIG. 8 depicts body cover dimensions and construction details. The body cover may include an external double-strapped torso belt and an internal single strap wide waist belt. In one or more instances, the body may be configured such that the overall length of the cover may be approximately 75 inches (190 cm), with a height of approximately 11 inches. These measurements may be estimates and may vary in different embodiments.

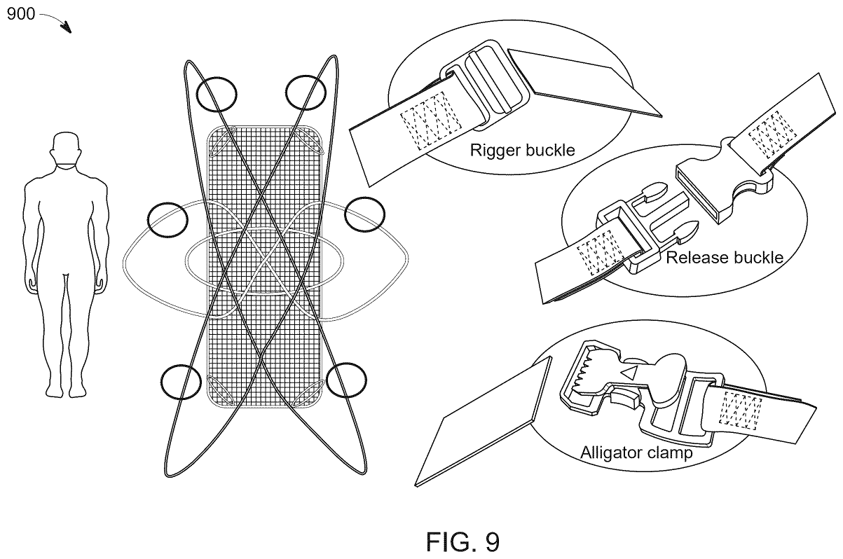

FIG. 9 shows optional design modification to incorporate adjustable carrier cross-body shoulder strap details, which may be an optional design feature. The adjustable straps may incorporate various types of buckles, such as rigger buckles, release buckles, and alligator clamps. In one or more embodiments, the medical evacuation litter 100 may also include adjustable carrier straps. These straps may allow for customization of the fit for different carrier heights and body types, potentially improving comfort and reducing fatigue during extended transport operations

In operation, the medical evacuation litter 100 may be used to transport injured individuals from combat zones or civilians over rough terrain. The patient may be secured within the tub-like structure 102 using appropriate restraints. Carriers may then engage with the medical evacuation litter 100 using the cross-body shoulder straps 104 and/or handles 106. The design of the medical evacuation litter 100 may allow it to be carried at approximately hip height of the carriers when the cross-body shoulder straps 104 are worn. This elevated position may provide freedom of movement for the carriers and reduce interference with their legs or objects on the ground, potentially allowing for more controlled and rapid movement. The configuration of the medical evacuation litter 100 may enable hands-free operation by the carriers. This feature may allow carriers to use their hands for other tasks, such as providing medical support to the patient, navigating difficult terrain, or responding to threats in combat situations.

The medical evacuation litter 100 may also include additional features to enhance its functionality and versatility. For example, the tub-like structure 102 may be constructed using lightweight rip-stop materials and military-grade webbing. This webbing may be box or diamond-stitched at intersections to provide maximum strength and durability. The specific overlapping of webbing may form a pattern that helps distribute the weight of the patient evenly across the structure when carried. The medical evacuation litter 100 may further comprise a body cover. This cover may include an external double-strapped torso belt and an internal single strap wide waist belt. These belts may help secure the patient firmly within the tub-like structure 102, providing additional stability during transport. The handles 106 may correspond to each of the cross-body shoulder straps 104. This configuration may allow carriers to use in conjunction or switch between using the straps and handles as needed, providing flexibility in how the medical evacuation litter 100 is carried. The dimensions of the tub-like structure 102 may be optimized for patient comfort and carrier efficiency, for instance, the structure may be approximately 27.5 inches tall, 20 inches wide at the middle, and 15 inches wide at the top corners. These dimensions may allow for a snug fit for most patients while maintaining a compact profile for easier maneuverability.

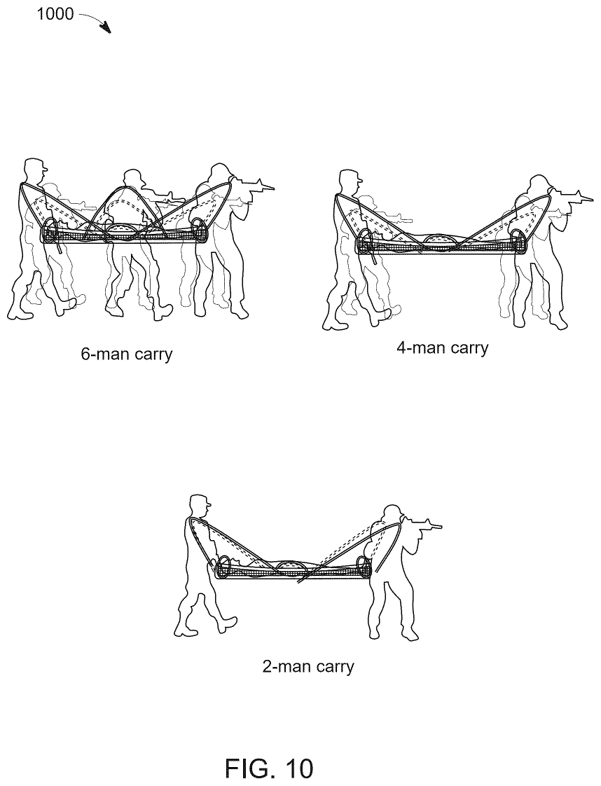

FIG. 10, in some embodiments, the medical evacuation litter 100 may be designed to distribute weight among a two-person, four-person or six-person carriers. This distribution may be driven by the number of available carriers present to assist and/or to help prevent individual carriers from bearing too much weight, potentially allowing for longer transport distances without fatigue.

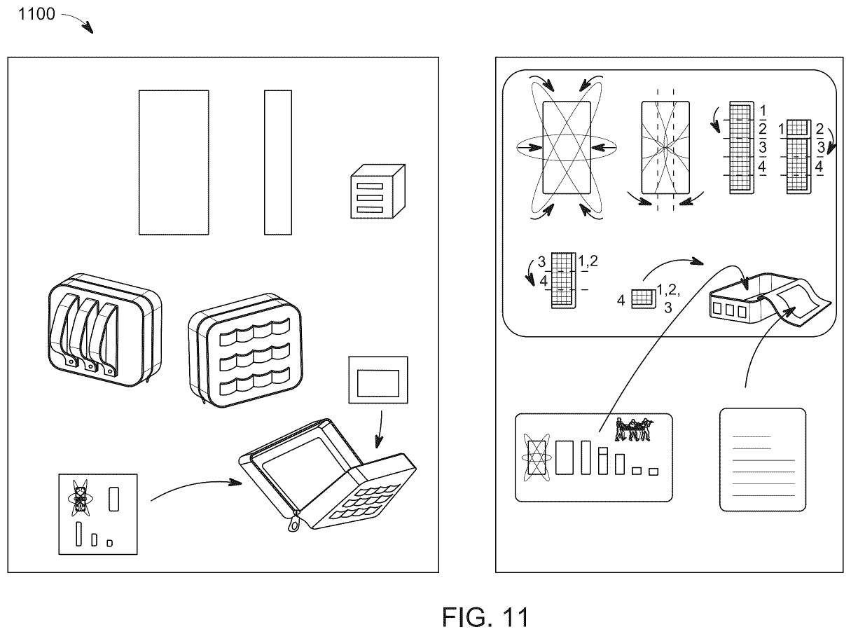

FIG. 11. the design of the medical evacuation litter 100 may also incorporate features to facilitate its storage and transport when not in use with a small zippered pouch. The design may be included stitched instructions placed on the inside of the carrier bag providing methods to collapse or fold the litter. Thus, allowing it to be easily stowed in vehicles or carried as part of a soldier's gear or Search and Rescue. The medical evacuation litter 100 may also incorporate additional features to enhance its functionality and versatility.

In one or more embodiments, the materials used in the construction of the medical evacuation litter 100 may be selected for their durability, lightweight properties, and resistance to environmental factors. This selection may help ensure the medical evacuation litter 100 remains functional in a variety of challenging conditions, from combat zones to disaster relief scenarios. For example, the tub-like structure 102 may be equipped with padding or cushioning material along its interior surfaces to provide comfort.

While specific embodiments have been described above, it may be appreciated that many modifications, permutations, additions, and sub-combinations may be possible. It may be understood that the present disclosure may include all such modifications, permutations, additions, and sub-combinations as may come within the scope of the appended claims and their equivalents.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims.

While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112 (f), unless the element is expressly recited using the exact phrase “means for . . . ” and no method or process step herein is to be construed under the provisions of 35 U.S.C. section 112 (f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A medical evacuation litter system comprising:
a tub-like structure configured to secure a patient;
a plurality of cross-body shoulder straps configured to be worn by multiple carriers; and
a plurality of handles integrated into the tub-like structure.

2. The system of claim 1, wherein the tub-like structure is configured to be carried at approximately hip height of the carriers when the cross-body shoulder straps are worn.

3. The system of claim 1, wherein the system is configured to allow hands-free operation by the carriers.

4. The system of claim 1, wherein the cross-body shoulder straps are configured to distribute weight among four to six carriers.

5. The system of claim 1, wherein the tub-like structure comprises at least one of: a lightweight rip-stop material and a military-grade webbing.

6. The system of claim 5, wherein the military-grade webbing is box or diamond-stitched at intersections.

7. The system of claim 1, further comprising a body cover with an external double-strapped torso belt and an internal single strap wide waist belt.

8. The system of claim 1, wherein the handles correspond to each of the cross-body shoulder straps.

9. The system of claim 1, wherein the tub-like structure is approximately 27.5 inches tall, 20 inches wide at the middle, and 15 inches wide at the top corners.

10. The system of claim 1, further comprising wherein the plurality of cross-body shoulder straps are adjustable cross-body shoulder straps.

11. A method of transporting an injured individual, the method comprising:
securing the individual in a tub-like structure of a medical evacuation litter;
engaging multiple carriers with the litter using cross-body shoulder straps;
elevating the litter to approximately hip height of the carriers; and
transporting the individual while maintaining freedom of movement for the carriers.

12. The method of claim 11, further comprising allowing hands-free operation by the carriers during transport.

13. The method of claim 11, wherein engaging multiple carriers comprises distributing weight among four to six carriers.

14. The method of claim 11, further comprising using handles integrated into the tub-like structure for additional support and maneuverability.

15. The method of claim 11, further comprising securing the individual with a body cover comprising an external double-strapped torso belt and an internal single strap wide waist belt.

16. A medical evacuation litter comprising:
a patient-securing structure;
a weight distribution system configured to engage with multiple carriers; and
a plurality of integrated support elements.

17. The litter of claim 16, wherein the weight distribution system comprises cross-body shoulder straps.

18. The litter of claim 16, wherein the integrated support elements comprise handles corresponding to each engagement point of the weight distribution system.

19. The litter of claim 16, wherein the patient-securing structure is configured to be carried at approximately hip height of the carriers when in use.

20. The litter of claim 16, wherein the litter is configured to allow hands-free operation by the carriers during transport of a patient.
